(19) United States
(12) Patent Application Publication
(10) Pub. No.: US 2012/0125833 A1
(43) Pub. Date: May 24, 2012

(54) FINE PARTICLE SEPARATOR

(75) Inventors: Hiroshi YAGI, Kamiina (JP); Satomi YOSHIOKA, Shiojiri (JP)

(73) Assignee: SEIKO EPSON CORPORATION, Tokyo (JP)

(21) Appl. No.: 13/299,741

(22) Filed: Nov. 18, 2011

(30) Foreign Application Priority Data
Nov. 19, 2010 (JP) 2010-258639

(51) Int. Cl. B01D 35/20

(52) U.S. Cl. 210/388

(57) ABSTRACT

A fine particle separator includes a channel having an inlet; a chamber; a filter that is in communication with the channel and the chamber; and a piezoelectric element that vibrates the filter. The piezoelectric element may be provided on the channel forming member, and may vibrate the filter via the channel forming member. The channel may include an outlet. With the piezoelectric element directly or indirectly vibrating the filter, particles or a solid phase can be suppressed from adhering to the filter, and from closing the through holes of the filter. As a result, clogging can be reduced.

### CROSS-REFERENCE

This application claims priority to Japanese Patent Application No. 2010-258639, filed Nov. 19, 2010, the entirety of which is hereby incorporated by reference.

### BACKGROUND

1. Technical Field

The present invention relates to fine particle separators.

2. Related Art

A fine particle separator is known that separates a desired solid-phase or solid particles from a liquid-phase and solid-phase turbid solution or a dispersion of solid particles in liquid. Such fine particle separators with a filter involve filter clogging during use, and a fine particle separator that can reduce filter clogging is needed.

As a technique to reduce filter clogging, JP-A-6-269274 describes a configuration with a mechanical oscillation mechanism that vibrates a porous screen (filter) via a shaft. JP-A-2001-15465 describes a configuration with an ultrasonic oscillation mechanism that vibrates a filter by applying ultrasonic waves to a liquid using an ultrasonic device.

However, miniaturization of mechanical oscillation mechanisms and ultrasonic oscillation mechanisms is difficult. Further, ultrasonic oscillation mechanisms have poor energy efficiency, because the filter is indirectly oscillated from a distant location. Another problem of ultrasonic oscillation mechanisms is that the vibrations cause serious damage to fine particles when delicate particles such as cells are used as the fine particles.

### SUMMARY

An advantage of some aspects of the invention is to provide a fine particle separator that can reduce filter clogging.

(1) An aspect of the invention is directed to a fine particle separator that includes: a channel that includes an inlet; a chamber; a filter in communication with the channel and the chamber; and a piezoelectric element that vibrates the filter.

In accordance with the aspect of the invention, the piezoelectric element is used to vibrate the filter, and thus the fine particle separator can be made smaller than with the mechanical oscillation mechanism or the ultrasonic oscillation mechanism. Further, the piezoelectric element can be provided closer to the oscillated filter than when using an ultrasonic oscillation mechanism. Clogging can thus be reduced with a smaller vibration energy than when using an ultrasonic oscillation mechanism. Further, because clogging can be reduced with a smaller vibration energy, the vibrations cause less damage to fine particles when delicate fine particles such as cells are used as the fine particles, compared to an ultrasonic oscillation mechanism.

(2) The fine particle separator may further include a channel forming member that forms the channel, wherein the piezoelectric element is provided on the channel forming member, and vibrates the filter via the channel forming member.

In this way, the fine particle separator capable of vibrating the filter can be produced by the simple procedure of providing the piezoelectric element on the channel forming member.

(3) The fine particle separator may further include a support member that supports the piezoelectric element by connecting a part of the piezoelectric element to an inner wall surface of the channel, wherein the piezoelectric element is provided in the channel.

In this way, because the piezoelectric element is supported in part, the piezoelectric element has more free area than when the whole surface of the piezoelectric element is supported, and vibration efficiency can be improved. Further, because the support member supports the piezoelectric element on the inner side of the channel, the filter is vibrated via a liquid flowing in the channel, without being mediated by the channel forming member. Clogging can thus be reduced with an even smaller vibration energy.

(4) The fine particle separator may include the piezoelectric element in the channel, in contact with the filter.

In this way, the piezoelectric element can directly vibrate the filter. Clogging can thus be reduced with an even smaller vibration energy.

(5) Another aspect of the invention is directed to a fine particle separator that includes: a channel with an inlet; a chamber; and a filter that includes a piezoelectric element and is in communication with the channel and the chamber.

In accordance with this aspect of the invention, the filter is configured to include a piezoelectric element, and can thus vibrate on its own. Clogging can thus be reduced with an even smaller vibration energy.

(6) The fine particle separator may include the channel with an outlet.

In this way, particles that did not pass through the filter can be discharged through the outlet, and clogging can be reduced.

### BRIEF DESCRIPTION OF THE DRAWINGS

The invention will be described with reference to the accompanying drawings, wherein like numbers reference like elements.

FIG. 1A is a plan view schematically representing a fine particle separator according to First Embodiment;

FIG. 1B is a cross sectional view taken at line A-A in FIG. 1A.

FIG. 2A is a plan view schematically representing a fine particle separator according to Second Embodiment;

FIG. 2B is a cross sectional view taken at line A-A in FIG. 2A.

FIG. 3A is a plan view schematically representing a fine particle separator according to Third Embodiment;

FIG. 3B is a cross sectional view taken at line A-A in FIG. 3A.

FIG. 4A is a plan view schematically representing a fine particle separator according to Fourth Embodiment;

FIG. 4B is a cross sectional view taken at line A-A in FIG. 4A.

FIG. 5A is a plan view schematically representing a fine particle separator according to a variation of Third Embodiment;

FIG. 5B is a cross sectional view taken at line B-B in FIG. 5A.

FIG. 6A is a plan view schematically representing a fine particle separator according to a variation of Fourth Embodiment;

FIG. 6B is a cross sectional view taken at line B-B in FIG. 6A.

FIG. 7A is a plan view schematically representing a fine particle separator according to another variation of Fourth Embodiment;

FIG. 7B is a cross sectional view taken at line A-A in FIG. 7A.

FIG. 8A is a plan view schematically representing a fine particle separator according to yet another variation of Fourth Embodiment;

FIG. 8B is a cross sectional view taken at line A-A in FIG. 8A.

FIG. 9 is a block diagram explaining a fine particle separator system that uses the fine particle separator according to First Embodiment.

FIG. 10 is a block diagram explaining a fine particle separator system that uses the fine particle separator according to a variation of Fourth Embodiment.

FIG. 11 is a block diagram explaining a fine particle separator system that uses the fine particle separator according to a variation of Fourth Embodiment.

### DESCRIPTION OF EXEMPLARY EMBODIMENTS

Preferred embodiments of the invention are described below with reference to the accompanying drawings. Note that the embodiments below do not unduly restrict the substance of the invention recited in the appended claims. It should also be noted that the configurations described below do not necessarily represent the necessary constituting elements of the invention.

### 1. Fine Particle Separator According to First Embodiment

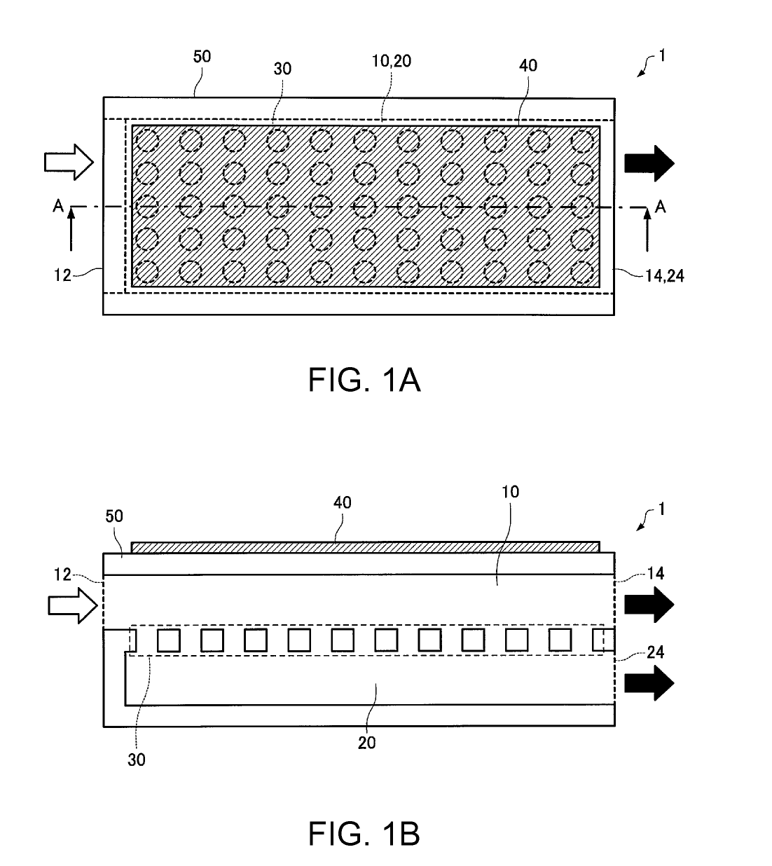

FIG. 1A is a plan view schematically representing a fine particle separator 1 according to First Embodiment. FIG. 1B is a cross sectional view taken at line A-A in FIG. 1A.

The fine particle separator 1 according to the present embodiment includes a channel 10 with an inlet 12, a chamber 20, a filter 30 in communication with the channel 10 and the chamber 20, and a piezoelectric element 40 that vibrates the filter 30.

The inlet 12 provided for the channel 10 is an opening through which a liquid-phase and solid-phase turbid solution or a dispersion of solid particles in liquid is introduced. Specifically, the channel 10 serves as a channel for flowing liquid or the like from the inlet 12 to the filter 30.

The channel 10 may also include an outlet 14 through which a liquid-phase and solid-phase turbid solution or a dispersion of solid particles in liquid is discharged. Specifically, the channel 10 may serve as a channel for flowing liquid or the like from the inlet 12 to the outlet 14. In this way, the particles and the solid phase that did not pass through the filter 30 can be discharged through the outlet 14. As a result, clogging can be reduced. The particles and the solid phase that did not pass through the filter 30 can thus be removed.

The cross sectional shape of the channel 10 as viewed along the direction of the liquid flow in the channel 10 is not particularly limited, and may be, for example, a rectangle. Further, the cross sectional shape of the channel 10 as viewed along the direction of the liquid flow in the channel 10 may be the same throughout or may vary over the distance from the inlet 12 to the outlet 14.

The chamber 20 is in communication with the channel 10 via the filter 30. The chamber 20 may have an outlet 24 as the discharge opening for the liquid. The shape of the chamber 20 is not particularly limited, and any shape may be formed according to the intended use. In the example illustrated in FIGS. 1A and 1B, the chamber 20 is configured to include the outlet 24, and thus serves as a channel for flowing the liquid flown through the filter 30 from the channel 10.

The filter 30 is in communication with the channel and the chamber 20. Specifically, in the example illustrated in FIGS. 1A and 1B, the chamber 20 is disposed downstream of the inlet 12 of the channel 10. In other words, the liquid flows into the chamber 20 from the channel 10 through the filter 30. The filter 30 has through holes through which the channel 10 and the chamber 20 are in communication with each other. The through holes of the filter 30 may have any shape at the openings to the channel 10 and the chamber 20. In the example illustrated in FIG. 1A, the through holes of the filter 30 are circular in shape at the openings to the channel 10 and the chamber 20. In the through holes of the filter 30, the size of the openings to the channel 10 and the chamber 20 may be appropriately set according to the size of the particles and the solid phase to be separated in the fine particle separator 1. For example, for the extraction of monocytes from the blood components collected from human peripheral blood, the diameter of the through hole openings to the channel 10 and the chamber 20 may be selected from a range of from 6.5 μm to 16.8 μm, which represents 50% to 80% of the typical monocyte diameter of about 13 to 20 μm. Smaller opening diameters in this range can improve the accuracy of monocyte separation. Larger opening diameters in this range enable the monocytes to be separated on the side of the channel 10 while ensuring a liquid volume that can be processed per hour.

The fine particle separator 1 may include a channel forming member 50 that forms the channel 10. The materials used to form the channel 10, the chamber 20, and the filter are not particularly limited. For example, the fine particle separator 1 according to First Embodiment can be produced by the injection molding of resin, or from materials such as a semiconductor substrate, a glass substrate, and an organic material substrate, using the MEMS (Micro Electro Mechanical Systems) technique. The fine particle separator according to First Embodiment also can be produced by appropriately combining, for example, grooved substrates and bored substrates.

The piezoelectric element 40 vibrates the filter 30. In the example illustrated in FIGS. 1A and 1B, the piezoelectric element 40 indirectly vibrates the filter 30 via the channel forming member 50 and via the liquid flowing through the channel 10. The vibrations applied by the piezoelectric element 40 may be constant or intermittent. The vibration wave of the piezoelectric element 40 is not particularly limited, and may be, for example, a sinusoidal wave or a rectangular wave of a predetermined frequency or of varying frequencies with time. The piezoelectric element 40 may have various known configurations, including, for example, the configuration of a capacitor-type piezoelectric element in which the piezoelectric unit is sandwiched between a pair of upper and lower electrodes. The piezoelectric element 40 of such a configuration can be produced using, for example, a thin film technique. The piezoelectric element 40 may be coated with high-insulation material.

The piezoelectric element 40 may be provided on the channel forming member 50, and may vibrate the filter 30 via the channel forming member 50. For example, the piezoelectric element 40 may be provided by being bonded with an adhesive or the like at the interface with the channel forming member 50.

In the example illustrated in FIGS. 1A and 1B, the piezoelectric element 40 is provided on the channel forming member 50 in a portion not facing the channel 10. Specifically, the piezoelectric element 40 vibrates the filter 30 via the channel forming member 50 and via the liquid flowing through the channel 10. Further, in the example illustrated in FIGS. 1A and 1B, the piezoelectric element 40 is provided on the channel forming member 50 in a portion not facing the channel 10, over a region that includes a portion covering an imaginary extended spatial region of the through holes of the filter 30. In this way, the vibrations of the piezoelectric element 40 are efficiently transmitted to the through holes of the filter 30, and the clogging of the filter 30 can be reduced with a smaller vibration energy.

The piezoelectric element 40 may be provided on the channel forming member 50 in a portion facing the channel 10, over a region that includes a portion covering an imaginary extended spatial region of the through holes of the filter 30. In this case, the piezoelectric element 40 is provided in the channel 10, and the clogging of the filter 30 can be reduced with an even smaller vibration energy. Note that, when the piezoelectric element 40 is provided in the channel 10, it is preferable that the piezoelectric element 40 be coated with material that provides sufficient flexibility and insulation, and that does not cause adverse effects on the liquid or particles introduced into the channel 10. For example, when the liquid introduced into the channel 10 contains a blood component, the piezoelectric element 40 may be coated with material such as polystyrene, polycarbonate, and acrylic resin.

In the fine particle separator 1 according to First Embodiment, the piezoelectric element 40 vibrates the filter 30 either directly or indirectly, and the particles or the solid phase can be suppressed from adhering to the filter 30, or from closing the through holes of the filter 30. As a result, clogging can be reduced.

Further, because the fine particle separator 1 according to First Embodiment uses the piezoelectric element 40 to vibrate the filter 30, the oscillation mechanism can be made smaller than when using the mechanical oscillation mechanism or the ultrasonic oscillation mechanism.

Further, in the fine particle separator 1 according to First Embodiment, the piezoelectric element 40 can be provided closer to the filter 30 being oscillated than when using the ultrasonic oscillation mechanism. Thus, clogging can be reduced with a smaller vibration energy than when using the ultrasonic oscillation mechanism. Further, because clogging can be reduced with a smaller vibration energy, less damage is caused to delicate fine particles such as cells, compared to using the ultrasonic oscillation mechanism.

Further, the fine particle separator 1 according to First Embodiment can be produced using a simple method, because the piezoelectric element 40 is provided on the channel forming member 50.

In the descriptions of the embodiments, variations and applications below, the same reference numerals are used for the same constituting elements described in First Embodiment, and detailed explanations thereof are omitted.

### 2. Fine Particle Separator According to Second Embodiment

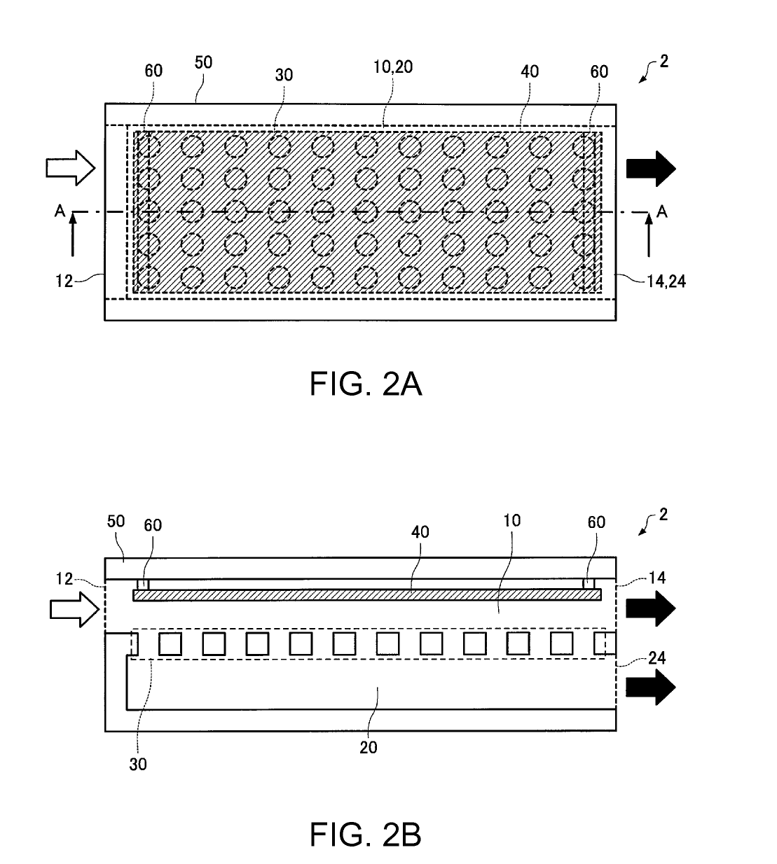

FIG. 2A is a plan view schematically representing a fine particle separator 2 according to Second Embodiment. FIG. 2B is a cross sectional view taken at line A-A in FIG. 2A.

The fine particle separator 2 according to Second Embodiment includes a support member 60 that supports the piezoelectric element 40 by connecting a part of the piezoelectric element 40 to the inner wall surface of the channel 10. The piezoelectric element 40 is provided in the channel 10.

In the example illustrated in FIGS. 2A and 2B, the support member 60 is configured to support the piezoelectric element 40 by connecting the piezoelectric element 40 at the portions near the lengthwise end portions to the channel forming member 50 representing the inner wall surface of the channel 10. Preferably, the support member 60 is formed using a material having high vibration absorption capability. Examples of such materials include rubber materials (such as elastomers).

In the example illustrated in FIGS. 2A and 2B, the piezoelectric element 40 is provided in the channel 10 by being supported by the support member 60 at portions near the lengthwise end portions. In this way, vibration efficiency can be improved, because the piezoelectric element 40 has more free area than when the whole surface of the piezoelectric element 40 is bonded to the channel forming member 50. Further, the piezoelectric element 40 vibrates the filter 30 via the liquid flowing through the channel 10, without being mediated by the channel forming member 50. The clogging of the filter 30 can thus be reduced with an even smaller vibration energy.

### 3. Fine Particle Separator According to Third Embodiment

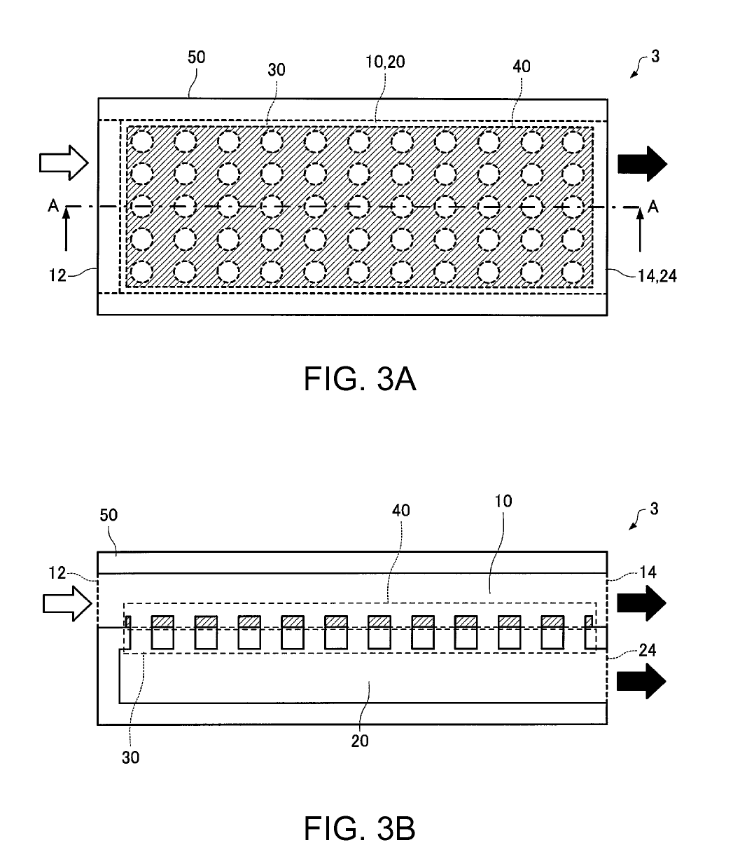

FIG. 3A is a plan view schematically representing a fine particle separator 3 according to Third Embodiment. FIG. 3B is a cross sectional view taken at line A-A in FIG. 3A.

In the fine particle separator 3 according to Third Embodiment, the piezoelectric element 40 is provided in the channel 10, in contact with the filter 30. In the example illustrated in FIGS. 3A and 3B, the piezoelectric element 40 is laminated on the filter 30 and bonded on the side of the channel 10. Further, in the example of FIGS. 3A and 3B, the piezoelectric element 40 has through holes in communication with the through holes of the filter 30.

The fine particle separator 3 according to Third Embodiment can directly vibrate the filter 30 with the piezoelectric element 40. Clogging can thus be reduced with an even smaller vibration energy.

Further, the fine particle separator 3 according to Third Embodiment can be produced using a simple method, for example, by laminating and bonding the piezoelectric element 40 to the filter 30. Note that, the piezoelectric element 40, laminated and bonded to the filter 30 on the side of the channel 10 in Third Embodiment, may be laminated and bonded to the filter 30 on the side of the chamber 20.

### 4. Fine Particle Separator According to Fourth Embodiment

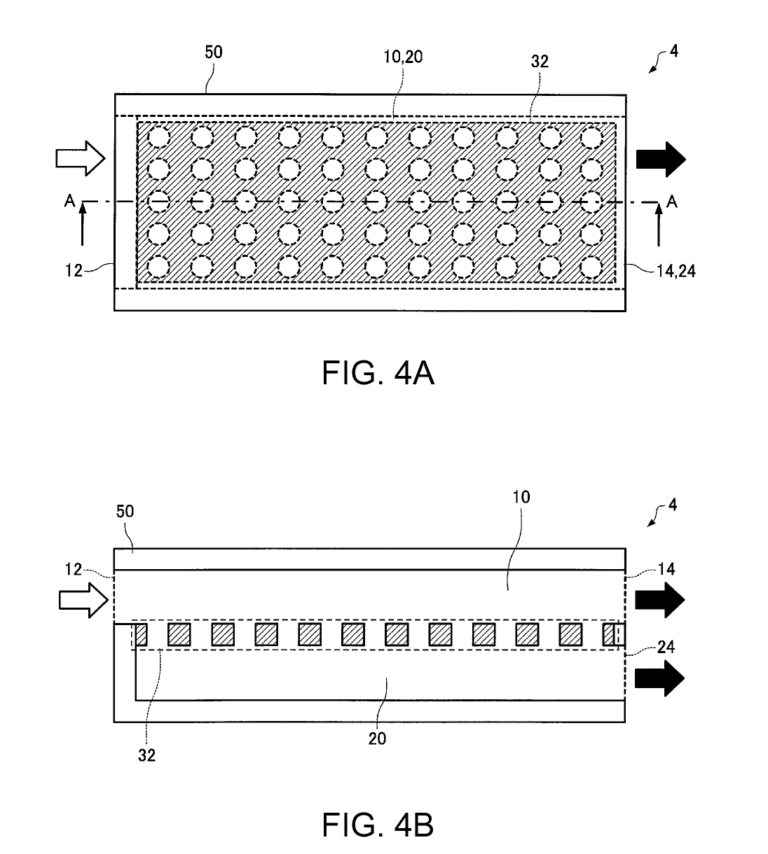

FIG. 4A is a plan view schematically representing a fine particle separator 4 according to Fourth Embodiment. FIG. 4B is a cross sectional view taken at line A-A in FIG. 4A.

The fine particle separator 4 according to Fourth Embodiment includes a channel 10 with an inlet 12, a chamber 20, and a filter 32 configured to include a piezoelectric element and in communication with the channel 10 and the chamber 20.

In the example illustrated in FIGS. 4A and 4B, the filter 32 is configured from a piezoelectric element. Specifically, the filter 32 is configured from a piezoelectric element that includes through holes in communication with the channel 10 and the chamber 20.

In the fine particle separator 4 according to Fourth Embodiment, the filter 32 is configured to include a piezoelectric element, and can thus vibrate on its own. In this way, clogging can be reduced with an even smaller vibration energy.

### 5. Variations

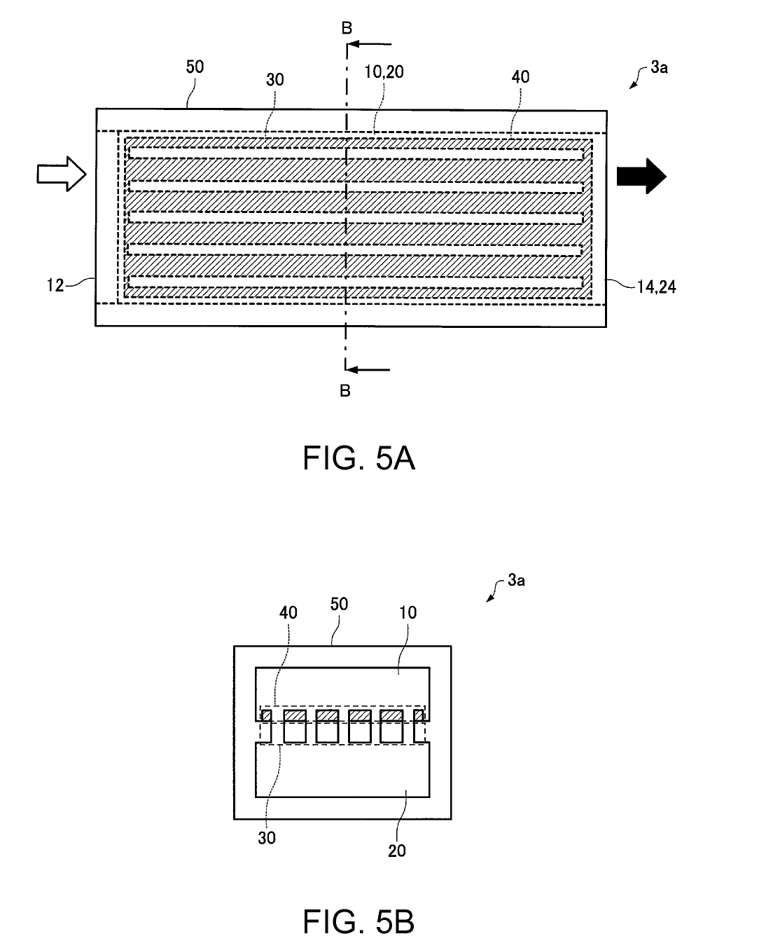

FIG. 5A is a plan view schematically representing a fine particle separator 3a according to a variation of Third Embodiment. FIG. 5B is a cross sectional view taken at line B-B in FIG. 5A.

In the example illustrated in FIGS. 5A and 5B, the through hole openings of the filter 30 to the channel 10 and the chamber 20 have a slit-like shape longer along the direction of the flow of the liquid introduced through the inlet 12 and flowing from the inlet 12 to the outlet 14. The slit width of the through hole openings of the filter 30 to the channel 10 and the chamber 20 may be appropriately set according to the size of the particles to be separated in the fine particle separator 3a. For example, for the extraction of monocytes from the blood components collected from human peripheral blood, the slit width of the through hole openings to the channel 10 and the chamber 20 may be selected from a range of from 6.5 μm to 16.8 μm, which represents 50% to 80% of the typical monocyte diameter of about 13 to 20 μm. Smaller slit widths in this range can improve the accuracy of monocyte separation. Larger slit widths in this range enable the monocytes to be separated on the side of the channel 10 while ensuring a liquid volume that can be processed per hour.

Note that the filter 30 may have the slit-like openings of FIGS. 5A and 5B also in the fine particle separator 1 according to First Embodiment and in the fine particle separator 2 according to Second Embodiment.

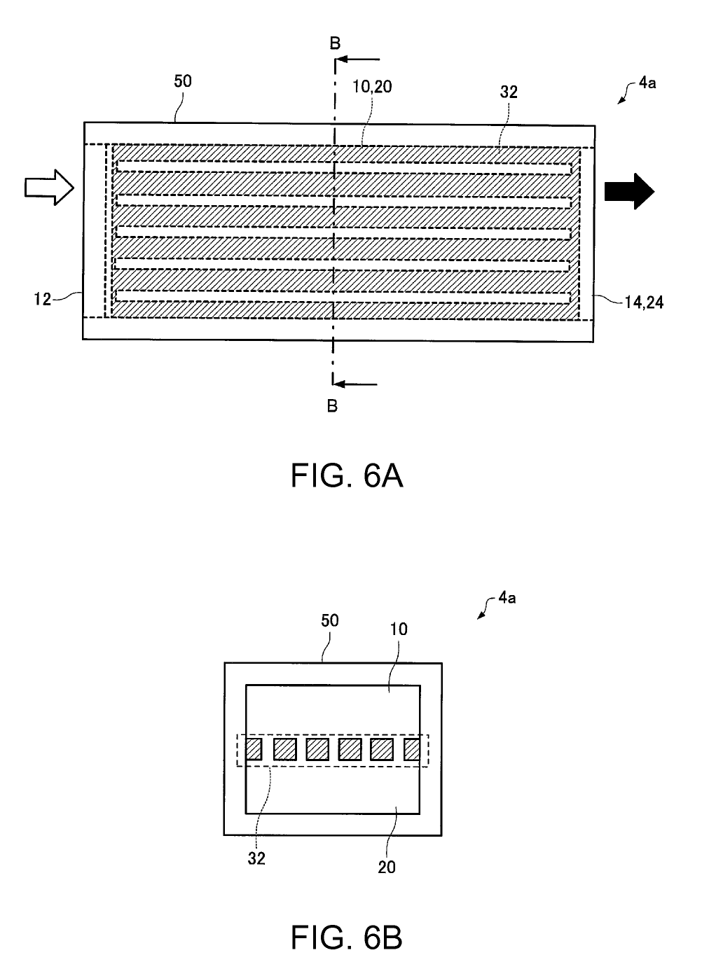

FIG. 6A is a plan view schematically representing a fine particle separator 4a according to a variation of Fourth Embodiment. FIG. 6B is a cross sectional view taken at line B-B in FIG. 6A.

In the example illustrated in FIGS. 6A and 6B, the through hole openings of the filter 32 to the channel 10 and the chamber 20 have a slit-like shape longer along the direction of the flow of the liquid introduced through the inlet 12 and flowing from the inlet 12 to the outlet 14. The slit width of the through hole openings of the filter 32 to the channel 10 and the chamber 20 may be appropriately set according to the size of the particles to be separated in the fine particle separator 4a, as in the fine particle separator 3a according to a variation of Third Embodiment.

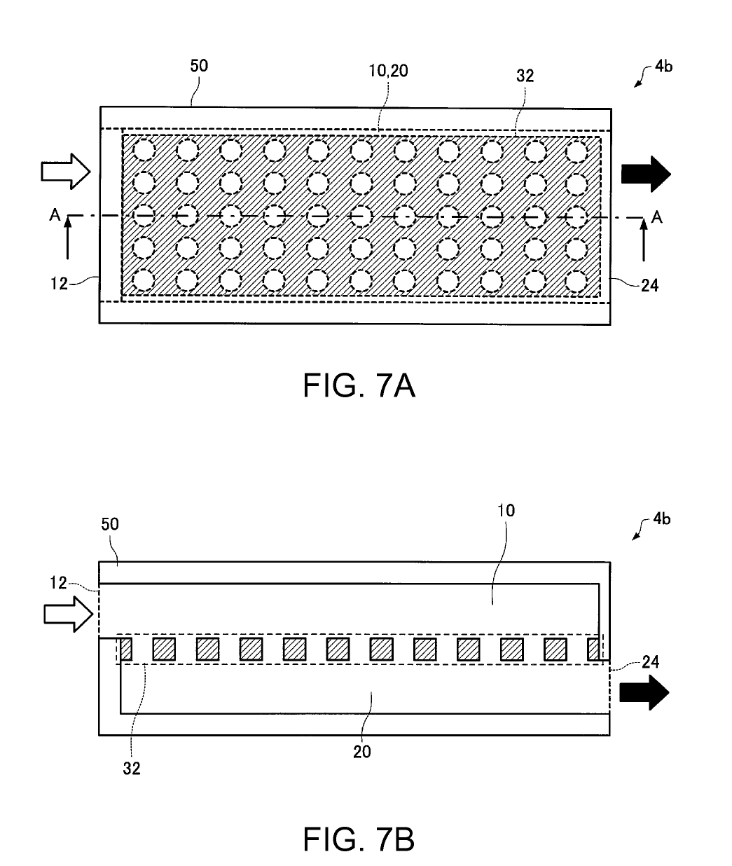

FIG. 7A is a plan view schematically representing a fine particle separator 4b according to yet another variation of Fourth Embodiment. FIG. 7B is a cross sectional view taken at line A-A in FIG. 7A.

The fine particle separator 4b according to yet another variation of Fourth Embodiment differs from the fine particle separator 4 according to Fourth Embodiment in that the channel 10 does not have the outlet 14. Specifically, the liquid or the like introduced through the inlet 12 is flown into the chamber 20 via the filter 32, excluding the particles and solid phase that did not pass through the filter 32. Despite the fact that the channel 14 does not have the outlet 14, the effect obtained with the fine particle separator according to Fourth Embodiment described in Section 4 still can be obtained under the same principle.

Note that the configuration in which the channel 10 does not have the outlet 14 is also applicable and equally effective in the fine particle separator 1 according to First Embodiment, the fine particle separator 2 according to Second Embodiment, the fine particle separator 3 according to Third Embodiment, the fine particle separator 3a according to a variation of Third Embodiment, and the fine particle separator 4a according to a variation of the Fourth Embodiment.

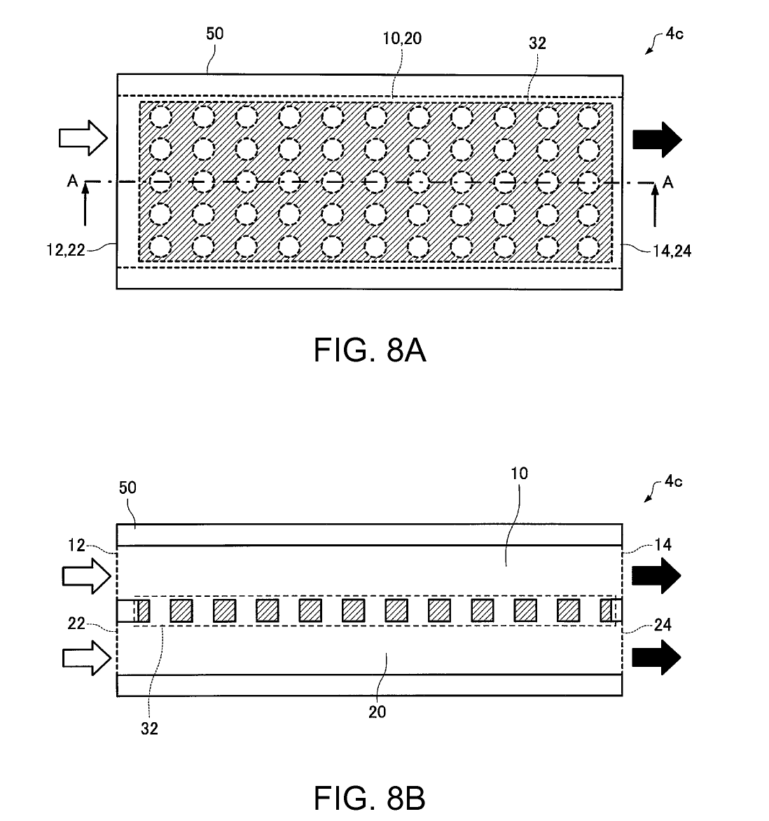

FIG. 8A is a plan view schematically representing a fine particle separator 4c according to still another variation of Fourth Embodiment. FIG. 8B is a cross sectional view taken at line A-A in FIG. 8A.

The fine particle separator 4c according to still another variation of Fourth Embodiment differs from the fine particle separator 4 according to Fourth Embodiment in that the chamber 20 has an inlet 22. Specifically, the chamber 20 can also serve as a channel for flowing liquid or the like from the inlet 22 to the outlet 24. With an auxiliary liquid introduced through the inlet 22 and that promotes a flow in the chamber 20, the particles and solid phase that have passed through the filter 32 can be suppressed from accumulating in the chamber 20.

The effect obtained with the fine particle separator according to Fourth Embodiment described in Section 4 also can be obtained in the fine particle separator 4c according to still another variation of Fourth Embodiment under the same principle.

Note that the configuration in which the chamber 20 has the inlet 22 is also applicable and equally effective in the fine particle separator 1 according to First Embodiment, the fine particle separator 2 according to Second Embodiment, the fine particle separator 3 according to Third Embodiment, the fine particle separator 3a according to a variation of the Third Embodiment, and the fine particle separator 4a according to a variation of the Fourth Embodiment.

### 6. Applications of Fine Particle Separator

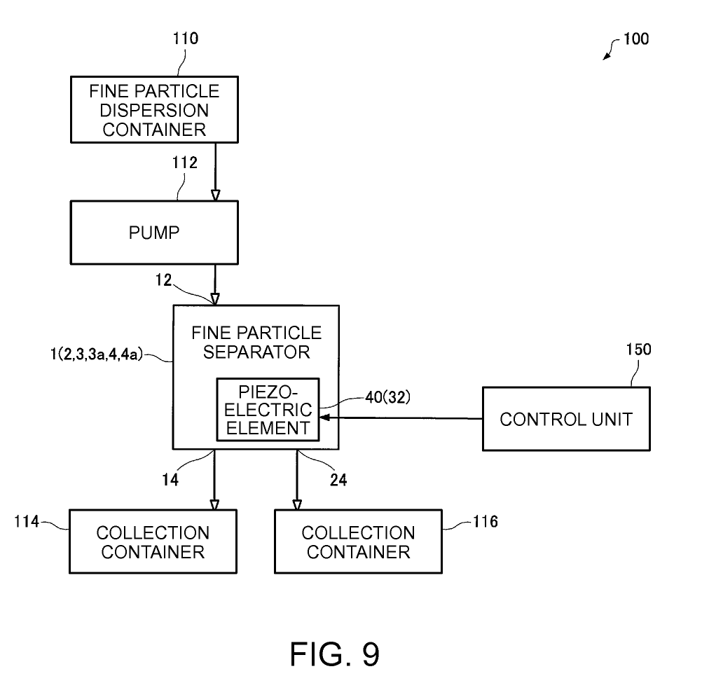

FIG. 9 is a block diagram explaining a fine particle separator system 100 that uses the fine particle separator 1 according to First Embodiment. In FIG. 9, the blank arrowhead indicates a liquid flow and piping, and the solid arrowhead a signal flow.

The fine particle separator system 100 represented in FIG. 9 includes a fine particle dispersion container 110, a pump 112, a fine particle separator 1, a collection container 114, a collection container 116, and a control unit 150.

The fine particle dispersion container 110 is in communication with the inlet 12 of the fine particle separator 1 via the pump 112. The fine particle dispersion container 110 contains a dispersion of solid particles in liquid. The pump 112 sends out the solid particle dispersion contained in the fine particle dispersion container 110 to the fine particle separator 1. The collection container 116 is in communication with the outlet 24 of the fine particle separator 1. The collection container 116 stores the liquid or the like discharged from the outlet 24 of the fine particle separator 1.

The collection container 114 stores the particles, liquid, and other components that did not pass through the filter 30 and discharged through the outlet 14 of the fine particle separator 1. For example, when the fine particle separator 1 is used to separate monocytes, reagents that induce the monocytes to dendritic cells may be added to the collection container 114, or the collection container 114 may be provided with a valve used for medium exchange. Further, inducing monocytes to dendritic cells in the collection container 114, the inner wall surface of the collection container 114 is preferably formed of a structure or a material that allows the dendritic cells to be easily detached. For example, the inner wall surface of the collection container 114 may be formed of a water-repellent material such as polytetrafluoroethylene (Teflon®), or a polymeric organic compound or inorganic compound with a hydrophilic coating, or may be structured to include microirregularities or microposts.

The control unit 150 supplies a drive signal to the piezoelectric element 40 to control the vibration of the piezoelectric element 40. The control unit 150 may be configured from a computer that includes a CPU (Central Processing Unit) and memory.

The fine particle separator system 100 can realize a closed-line fine particle separator system. Further, a fine particle separator system can be realized that does not require a special procedure of collecting fine particles that did not pass through the filter.

Though the foregoing application is based on the fine particle separator 1 according to First Embodiment, the fine particle separator system also can be realized and the same effects can be obtained with the fine particle separator 2 according to Second Embodiment, the fine particle separator 3 according to Third Embodiment, the fine particle separator 3a according to a variation of Third Embodiment, the fine particle separator 4 according to Fourth Embodiment, and the fine particle separator 4a according to a variation of Fourth Embodiment. Note that, when using the fine particle separator according to Fourth Embodiment and the fine particle separator 4a according to a variation of Fourth Embodiment, the control unit 150 controls the piezoelectric element that forms the filter 32.

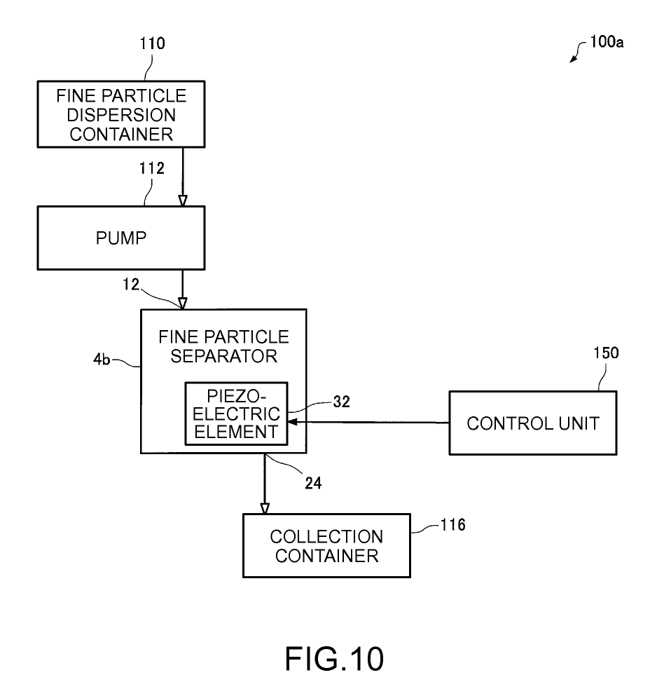

FIG. 10 is a block diagram explaining a fine particle separator system 100a that uses the fine particle separator 4b according to a variation of Fourth Embodiment. In FIG. 10, the blank arrowhead indicates a liquid flow and piping, and the solid arrowhead a signal flow. The same reference numerals are used for the same constituting elements described in the fine particle separator system 100 that uses the fine particle separator 1 according to First Embodiment, and detailed explanations thereof are omitted.

The fine particle separator system 100a using the fine particle separator 4b according to a variation of Fourth Embodiment differs from the fine particle separator system 100 in that the fine particle separator 4b does not include the outlet 14, and that the collection container 114 in communication with the outlet 14 is not provided. Another difference from the fine particle separator system 100 is that the control unit 150 of the fine particle separator system 100a controls the piezoelectric element that forms the filter 32.

The fine particle separator system 100a can realize a closed-line fine particle separator system.

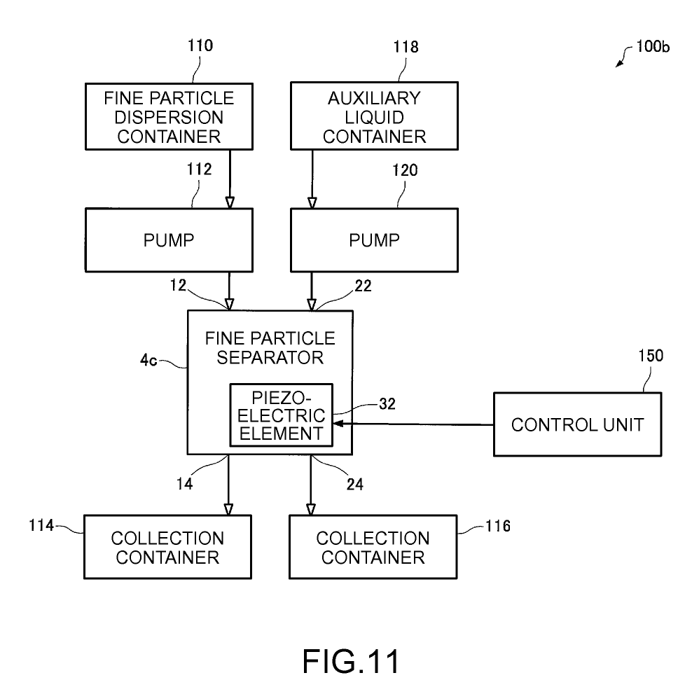

FIG. 11 is a block diagram explaining a fine particle separator system 100b that uses the fine particle separator 4c according to a variation of Fourth Embodiment. In FIG. 11, the blank arrowhead indicates a liquid flow and piping, and the solid arrowhead a signal flow. The same reference numerals are used for the same constituting elements described in the fine particle separator system 100 that uses the fine particle separator 1 according to First Embodiment, and detailed explanations thereof are omitted.

In the fine particle separator system 100b that uses the fine particle separator 4c according to a variation of Fourth Embodiment, the fine particle separator 4c includes the inlet 22, and accordingly the difference from the fine particle separator system 100 is the provision of a pump 120, and an auxiliary liquid container 118 in communication with the inlet 22 via the pump 120. The auxiliary liquid container 118 stores an auxiliary liquid (for example, such as phosphate buffer) that promotes a flow in the chamber 20 of the fine particle separator 4c. The control unit 150 of the fine particle separator system 100b differs from its counterpart in the fine particle separator system 100 in that the control unit 150 controls the piezoelectric element that forms the filter 32.

The fine particle separator system 100b can realize a closed-line fine particle separator system. Further, a fine particle separator system can be realized that does not require a special procedure for collecting the fine particles that did not pass through the filter. Further, because the auxiliary liquid that promotes a flow in the chamber 20 of the fine particle separator 4c is introduced through the inlet 22, the particles that have passed through the filter 32 can be suppressed from accumulating in the chamber 20.

Note that the foregoing embodiments and variations are merely illustrative and are not limiting in any sense. For example, one or more of the embodiments and variations above may be appropriately combined.

The invention is not restricted by the foregoing embodiments, and may be modified in various ways. For example, the invention encompasses configurations essentially the same as those described in the embodiments (for example, configurations with the same functions, methods, and results, and configurations with the same objects and effects). Further, the invention also encompasses configurations that have replaced the non-essential parts of the configurations described in the embodiments. Further, the invention also encompasses configurations that have the same advantages as the configurations of the foregoing embodiments, and configurations that can achieve the same object as that of the embodiments. The invention also encompasses configurations that add a known technique to the configurations described in the embodiments.

What is claimed is:

1. A fine particle separator comprising:
a channel that includes an inlet;
a chamber;
a filter in communication with the channel and the chamber; and
a piezoelectric element that vibrates the filter.

2. The fine particle separator according to claim 1, further comprising:
a channel forming member that forms the channel,
wherein the piezoelectric element is provided on the channel forming member, and vibrates the filter via the channel forming member.

3. The fine particle separator according to claim 1, further comprising:
a support member that supports the piezoelectric element by connecting a part of the piezoelectric element to an inner wall surface of the channel,
wherein the piezoelectric element is provided in the channel.

4. The fine particle separator according to claim 1, wherein the piezoelectric element is provided in the channel, in contact with the filter.

5. A fine particle separator comprising:
a channel that includes an inlet;
a chamber; and
a filter that includes a piezoelectric element and is in communication with the channel and the chamber.

6. The fine particle separator according to claim 1, wherein the channel includes an outlet.
